(19) United States
(12) Patent Application Publication
(10) Pub. No.: US 2025/0278209 A1
(43) Pub. Date: Sep. 4, 2025

(54) INCOMPLETE SUPERBLOCK TECHNIQUES

(71) Applicant: Micron Technology, Inc., Boise, ID (US)

(72) Inventors: Dionisio Minopoli, Frattamaggiore (NA) (IT); Giuseppe D'Eliseo, Caserta (IT); Giuseppe Ferrari, Napoli (IT); Luigi Esposito, Piano di Sorrento (NA) (IT)

(21) Appl. No.: 19/063,827

(22) Filed: Feb. 26, 2025

Related U.S. Application Data
(60) Provisional application No. 63/561,096, filed on Mar. 4, 2024.

(51) Int. Cl. G06F 3/06

(52) U.S. Cl. CPC G06F 3/064; G06F 3/0619; G06F 3/0679

(57) ABSTRACT

Methods, systems, and devices for incomplete superblock techniques are described. The described techniques provide for a memory system to perform bad block replacement procedures without increasing a size of a bad block table. For example, the memory system may consolidate bad physical blocks such that a quantity of complete superblocks and incomplete superblocks are maximized within a memory array. The memory system may refrain from including replacement mappings for complete superblocks and incomplete superblocks, and may dynamically access data from the memory array according to one or more functions according to a type of superblock associated with each complete superblock and incomplete superblock.

### CROSS REFERENCE

The present Application for Patent claims priority to U.S. Patent Application No. 63/561,096 by Minopoli et al., entitled “INCOMPLETE SUPERBLOCK TECHNIQUES,” filed Mar. 4, 2024, which is assigned to the assignee hereof, and which is expressly incorporated by reference in its entirety herein.

### TECHNICAL FIELD

The following relates to one or more systems for memory, including incomplete superblock techniques.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports incomplete superblock (ICS) techniques in accordance with examples as disclosed herein.

FIGS. 2-4 show examples of flowcharts that support ICS techniques in accordance with examples as disclosed herein.

FIG. 5 shows an example of a memory array that supports ICS techniques in accordance with examples as disclosed herein.

FIG. 6 shows an example of a process that supports ICS techniques in accordance with examples as disclosed herein.

FIG. 7 shows a block diagram of a memory system that supports ICS techniques in accordance with examples as disclosed herein.

FIG. 8 shows a flowchart illustrating a method or methods that support ICS techniques in accordance with examples as disclosed herein.

### DETAILED DESCRIPTION

A memory system may support firmware operations including bad block replacement for one or more blocks of memory cells. The memory system may include one or more memory dies, which may each be associated with a respective set of planes (e.g., six planes per memory die). In some cases, one or more controllers associated with the memory system may identify a quantity of physical blocks (PBs) (e.g., thirty-two PBs) associated with each plane of the memory system. The one or more controllers may scan the one or more memory dies to identify a total quantity of PBs of the memory system and may identify a status (e.g., an operational status) of each PB. For example, the one or more controllers may identify whether each PB operates as intended (e.g., a “good” block) or does not operate as intended (e.g., a “bad” block).

In some examples, the memory system may perform a replacement operation to replace bad blocks with good blocks. Replacement blocks may be identified using a bad block table (BBT) stored in a cache (e.g., random access memory (RAM), such as a static RAM (SRAM)) of the memory device, and as a quantity of block replacements increases, a size of the BBT may increase. The BBT may occupy or otherwise consume resources used for other operations of the memory device, such as SRAM storage, and the memory system may limit a size of the BBT to avoid disrupting such other operations. However, as the quantity of entries in the BBT increases, the memory system may be unable to store all the replacement mappings for the one or more blocks of memory cells according to the BBT size constraints.

As described herein, a memory system may utilize dynamic functions for managing bad blocks in one or more memory dies to reduce a size of, or otherwise eliminate the need for, a BBT. In some cases, the memory system may scan the one or more memory dies to identify a one or more virtual blocks (VBs), which may be referred to herein as superblocks. In some cases, each VB may correspond to a respective set of physical blocks associated with each plane of the memory device. For example, if the memory system includes two memory dies each including six planes, and each plane includes thirty-two PBS, the memory system may identify thirty-two VBs, where each of the VBs may correspond to a respective set of twelve PBs including one PB from each plane of the memory system (e.g., twelve total planes across the two memory dies). In some examples, the memory system may identify whether each VB corresponds to a complete superblock (CS) (e.g., each physical block of the VB is a good block), an incomplete superblock (ICS) (e.g., one physical block of the VB is a bad block), or a block replacement VB (e.g., at least two physical blocks of the VB are bad blocks).

In some cases, the memory system may replace bad blocks in the memory dies such that a quantity of CSs and ICSs are maximized. For example, the memory system may perform a block replacement procedure to consolidate bad blocks into replacement blocks, and may refrain from including replacement mappings for CSs and ICSs in the BBT. The memory system may then access data associated with the CSs and ICSs according to one or more functions, which may be used to dynamically identify respective PBs without storing an associated mapping, based on a type of the CS or ICS. Such techniques may reduce a size of, or otherwise eliminate the need for, the BBT while enabling the memory system to perform block replacement, which may improve subsequent access procedures and may enable the memory system to manage relatively greater quantities of ICSs.

In addition to applicability in memory systems as described herein, ICS techniques may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by supporting dynamic accessing of data using functions to identify good blocks, which may reduce a size of a BBT, thereby improving storage utilization (e.g., improving RAM or SRAM utilization), among other benefits.

In addition to applicability in memory systems as described herein, ICS techniques may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by supporting dynamic accessing of data using functions to identify good blocks, which may reduce a size of a BBT, thereby improving storage utilization (e.g., improving RAM or SRAM utilization), among other benefits.

Features of the disclosure are illustrated and described in the context of systems, devices, and circuits. Features of the disclosure are further illustrated and described in the context of flowcharts, a memory array, and a process flow.

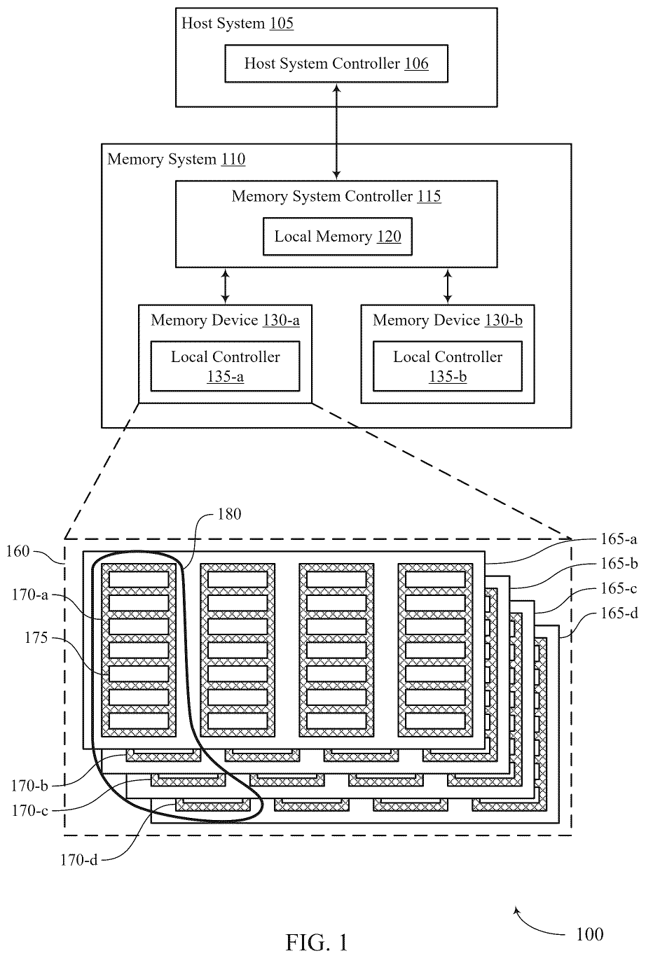

FIG. 1 shows an example of a system 100 that supports ICS techniques in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCle) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCle interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically crasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., crased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support ICS techniques. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the system 100 may support one or more features (e.g., mNAND features) to increase NAND yield, such as smart die matching (SDM). For example, with SDM support, a subset of VBs (e.g., superblocks) may be ICSs, which may refer to superblocks having N−1 good planes (e.g., good PBs) where N is a total quantity of planes 165 across all dies 160 of a memory device 130. In some cases, if a quantity of ICSs in the memory device 130 is relatively small (e.g., below a threshold), the mappings associated with ICSs may be stored an L2P table (e.g., SDM may support storing only the L2P table (SDM-T)). In some cases, if a quantity of ICSs is in the memory device 130 is relatively high (e.g., above a threshold), the ICSs may be used as data VBs (e.g., SDM may support storing user data (SDM-D)).

To simplify such systems (e.g., mNAND firmware) and avoid performance fluctuations, the memory system 110 may support prioritizing ICSs within a memory device 130 (e.g., a “pure” ICS implementation). For example, the memory device 130 may convert CSs to ICSs, where CSs may donate a good PB to create a new ICS (e.g., to avoid a loss in memory device 130 capacity). As such, for every N−1 CS, a new ICS may be created (e.g., diagonal ICSs as described herein). As described herein, a good PB may refer to a PB that operates as intended if the memory device 130 performs various operations (e.g., a PB that may be erased, programmed, read, or any combination thereof) and a bad PB may refer to a PB that does not operate as intended or produces unreliable results if the memory device 130 performs various operations.

In some cases, the memory system 110 may use a BBT to manage replacement of bad PBs discovered during firmware loading (e.g., carly bad blocks) and bad PBs created during mNAND lifetime (e.g., late bad blocks). A size of the BBT may be relevant to mNAND controller RAM and NAND occupation, due to the BBT being maintained in retention during low power states (e.g., occupying RAM space). Accordingly, to avoid the BBT occupying a significant portion of RAM space, the memory system 110 may limit a size of the BBT (e.g., no greater than 16 KB). In some examples, the size of the BBT may be determined according to a quantity of dies 160, a quantity of planes 165 per die 160, a maximum quantity of bad PBs per plane 165 (e.g., which may increase with ICS support), or any combination thereof. However, as a quantity of ICSs increases, the BBT size may increase (e.g., with 10% or 20% ICS, the BBT size may be greater than 32 KB for eight dies 160 and six planes 165 per die 160).

To reduce the size of the BBT, the memory system 110 may support dynamically accessing data in a pure ICS scheme according to one or more functions. In some cases, the memory system 110 may replace bad blocks in the memory dies such that a quantity of CSs and ICSs are maximized. For example, the memory system 110 may perform a block replacement procedure to consolidate bad PBs, and may refrain from including replacement mappings for CSs and ICSs in the BBT. The memory system 110 may then access data associated with the CSs and ICSs according to one or more functions (e.g., identified dynamically without storing a mapping) based on a type of the CS or ICS. Such techniques may reduce a size of the BBT while enabling the memory system 110 to perform block replacement, which may improve subsequent access procedures and enable the memory system 110 to manage relatively higher percentages of ICSs.

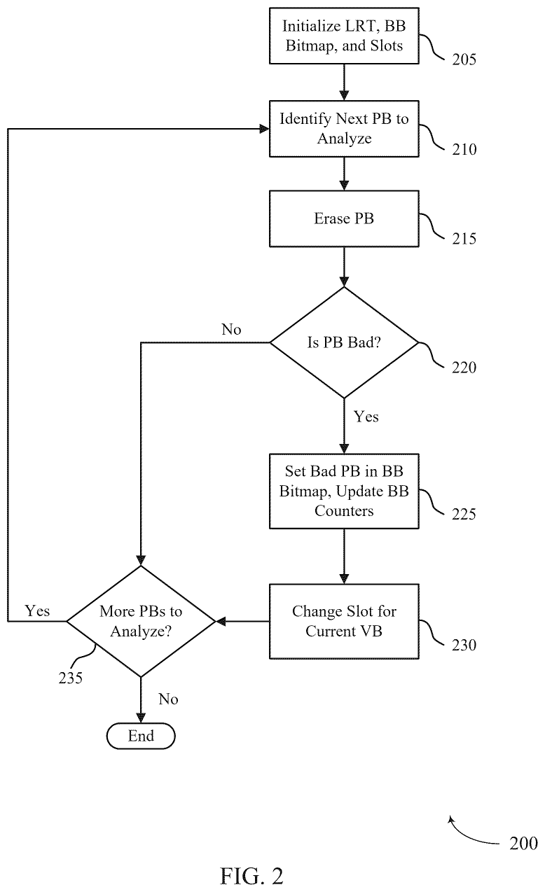

FIG. 2 shows an example of a flowchart 200 that supports ICS techniques in accordance with examples as disclosed herein. The flowchart 200 may implement, or be implemented by, one or more aspects of the system 100. For example, the flowchart 200 may illustrate operations performed by a memory system, which may be an example of a memory system 110 described with reference to FIG. 1. In some examples, the flowchart 200 may support the memory system creating a bad block bitmap and a large replacement table (LRT) associated with one or more memory dies of the memory system. Alternative examples of the following may be implemented, where some steps are performed in a different order or not at all. Additionally, some steps may include additional features not mentioned below.

At 205, the memory system may initialize one or more lists (e.g., data structures), such as an LRT, a bad block bitmap, and a set of slot lists. For example, the memory system may initialize the LRT, which may be a temporary table used by the memory system to support generating (e.g., building) a BBT. The LRT may include one entry for each plane of the memory system per VB (e.g., twelve entries per VB for two memory dies each including six planes), and each entry may contain an indication of which block replaces a currently indexed block.

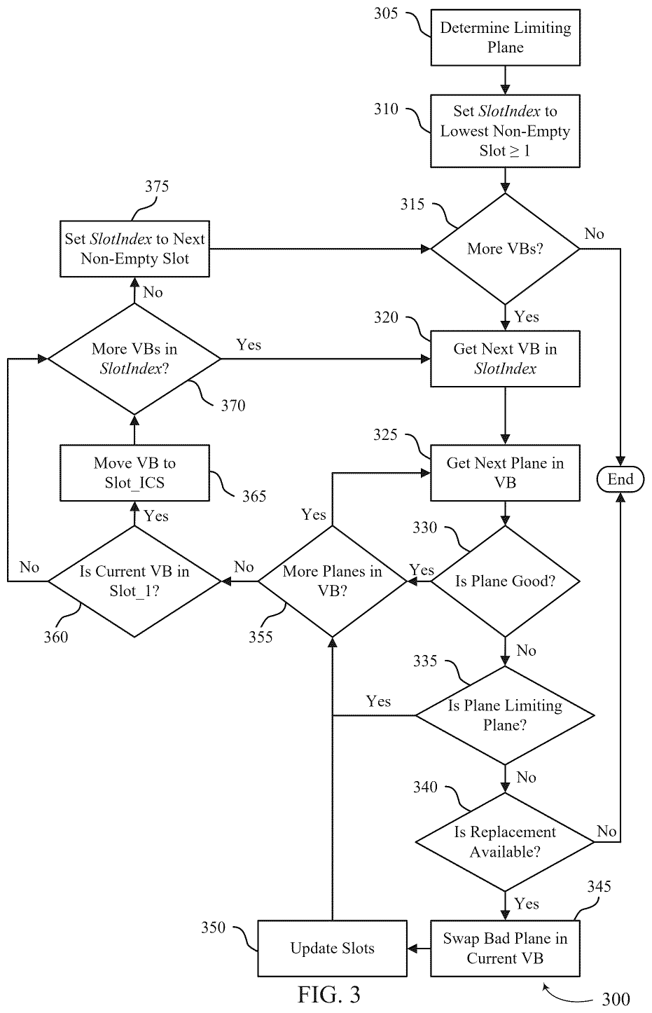

Initially, the LRT may include no replacements. Additionally, the memory system may initialize the bad block bitmap, which may include a bit for each PB in the memory system, where a binary value of the bit may indicate whether each PB is good or bad (e.g., binary value ‘1’ indicates a bad block). Further, the memory system may initialize the set of slot lists, which may include one slot list for each value of zero through a quantity of planes in each VB (e.g., one slot for each value of [0, NUM_PLANES_IN_VB]). In some cases, each slot list may be associated with a quantity of bad blocks (e.g., X bad blocks) and may be configured to include each VB having the quantity of bad blocks (e.g., a VB including X bad blocks). Additionally, an extra slot list of the set of slot lists may be reserved for VBs including a bad block in a limiting plane (e.g., SLOT_ICS), which may be populated in accordance with techniques described with reference to FIG. 3.

At 210, the memory system may identify a next PB to analyze. For example, the memory system may first identify a PB associated with a first VB and a first plane of the first VB (e.g., VB 0, plane 0).

At 215, the memory system may erase the identified PB, which may support the memory system identifying whether the PB is a good block or is a bad block. For example, the memory system may identify that the PB is good if the erase operation is successfully completed or may identify that the PB is bad if the erase operation is unsuccessfully completed.

At 220, the memory system may determine whether the identified PB is good or bad. For example, the memory system may identify whether the PB works correctly (e.g., a ‘good’ PB) or does not work correctly or is otherwise defective (e.g., a ‘bad’ PB). In some cases, if the memory system determines that the PB is bad, the memory system may move to step 225 of the flowchart 200. Alternatively, if the memory system determines that the PB is good, the memory system may move to step 235 of the flowchart 200.

At 225, the memory system may set the bad PB in the bad block bitmap and update one or more bad block counters. For example, the memory system may identify a bit in the bad block bitmap corresponding to the current PB, and may set the bit from a first value to a second value (e.g., from binary value ‘0’ to binary value ‘1’, or vice versa), where the second value indicates that the PB is bad. Additionally, the memory system may increment a bad block counter to indicate the presence of the bad PB.

At 230, the memory system may change a slot list for the current VB based on determining the PB is bad and setting the bit in the bad block bitmap. That is, the memory system may update the slot list for a current VB according to how many PBs of the current VB have been identified as ‘bad’ PBs. As an example, the VB 0 may initially be included in the SLOT_0, which may include VBs having zero bad blocks (e.g., across the planes of the memory system). In such an example, if the memory system identifies that a PB of the VB 0 is bad, the memory system may move the VB 0 to a next slot list of the set of sot lists, such as SLOT_1 including VBs having one bad block.

At 235, the memory system may determine whether there are more PBs of the memory system to analyze. For example, the memory system may determine that a current VB includes more PBs to analyze (e.g., across one or more planes of the memory system) or that the memory system includes a VB subsequent to the current VB (e.g., the current VB is not the last VB of the memory system). In such examples, the memory system may identify the next PB and return to step 210 and perform analysis on the next PB (e.g., in accordance with steps 210 through 230).

Alternatively, if the memory system determines that all PBs of the memory system have been analyzed (e.g., the current PB corresponds to the last plane of the last VB of the memory system), the memory system may terminate the flowchart 200. At termination of the flowchart 200, the memory system may have generated a LRT indicating replacement mappings for the PBs of the memory system, a bad block bitmap indicating bad PBs within the memory system, and a set of slot lists including VBs having a quantity of bad PBs corresponding to an index of the set of slot lists, which may support the memory system generating a BBT with a reduced size.

FIG. 3 shows an example of a flowchart 300 that supports ICS techniques in accordance with examples as disclosed herein. The flowchart 300 may implement, or be implemented by, the system 100 and the flowchart 200. For example, the flowchart 300 may illustrate an example of operations performed by a memory system, such as a memory system 110 described with reference to FIG. 1, to organize PBs of the memory system using a LRT and a set of slots lists, which may be examples of corresponding aspects generated with reference to FIG. 2. In some cases, the flowchart 300 may support the memory system performing PB replacements within one or more memory dies to generate a quantity of CSs and ICSs (e.g., maximizing the quantity CSs and ICSs across the one or more memory dies). Alternative examples of the following may be implemented, where some steps are performed in a different order or not at all. Additionally, some steps may include additional features not mentioned below.

At 305, the memory system may determine a limiting plane of the one or more memory devices. The limiting plane may refer to a plane of the memory system that includes a highest quantity of bad PBs across each VB of the memory system. For example, the memory system may identify the limiting plane using a bad block bitmap (e.g., generated according to techniques described with reference to FIG. 2), which may indicate which plane of the memory system includes the highest quantity of bad PBs. In some cases, the memory system may store an indication of the limiting plane.

At 310, the memory system may set a parameter corresponding to an index of a set of slot lists (e.g., SlotIndex) to a lowest non-empty slot index that is greater or equal to one, where each slot list of the set of slot lists may include a list of VBs including a quantity of bad PBs corresponding to an index of the slot list (e.g., in accordance with techniques described with reference to FIG. 2). For example, the memory system may refrain from selecting a slot list corresponding to index zero due to VBs included in the slot list including no bad PBs (e.g., VBs already corresponding to CSs). Additionally, the memory system may refrain from selecting a slot list including no VBs. For example, the memory system may skip the slot list corresponding to index one and may select the slot list corresponding to index two if the slot list corresponding to index one includes no VBs and the slot list corresponding to index two includes at least one VB.

At 315, the memory system may identify whether more VBs are available for analysis in the memory system. In some cases, if the memory system identifies that there are more VBs to analyze, the memory system may move to operation 320. Alternatively, if the memory system identifies that there are no more VBs to analyze (e.g., the memory system has finished analyzing each VB), the memory system may terminate the flowchart 300.

At 320, the memory system may identify a next VB in a current slot list index.

At 325, the memory system may identify a next plane in the identified VB (e.g., a next PB corresponding to the VB and plane).

At 330, the memory system may identify whether the PB corresponding to the identified VB and identified plane is good. For example, the memory system may identify a status of the PB according to the bad block bitmap, via an analysis of the PB, or both. In some examples, if the memory system determines that the PB is bad, the memory system may move to operation 335. Alternatively, if the memory system determines that the PB is good, the memory system may move to operation 355.

At 335, the memory system may determine whether a current plane is the limiting plane (e.g., determined at operation 305) based on identifying that a PB is bad. In some examples, if the memory system determines that the plane is not the limiting plane, the memory system may move to operation 340 (e.g., to attempt a replacement procedure). Alternatively, if the memory system determines that the plane is the limiting plane, the memory system may move to operation 355 (e.g., the memory system may skip bad PBs in the limiting plane due to no replacements occurring within the limiting plane).

At 340, the memory system may determine whether a replacement block is available for a current bad PB based on identifying that the plane associated with the PB is not the limiting plane. For example, the memory system may scan each slot list corresponding to an index greater than the index of the slot list including the current VB (e.g., scanning Slot N−1 down to the SlotIndex of the current VB). In some cases, the memory system may identify an available replacement block if any VBs included in a higher slot list index (e.g., a VB having a higher quantity of bad PBs than the current VB) includes a good PB at the current plane, and may move to operation 345.

Alternatively, the memory system may identify that no replacement blocks are available if no VBs included in a higher slot list index include a good PB at the current plane. In such cases, the memory system may terminate the flowchart 300 due to no replacements being available in a non-limiting plane, which may indicate that no more CSs and ICSs can be formed within the memory system.

At 345, the memory system may swap the bad PB in the current (non-limiting) plane with a replacement block (e.g., identified via the LRT) based on determining that a replacement PB is available. For example, the memory system may set the replacement PB in place of the bad PB in the LRT and may set the bad current PB in place of the replacement PB in the LRT.

At 350, the memory system may update the slot lists based on swapping the bad PB and the replacement PB. As an example, if the current VB is included in the slot list corresponding to index two and the VB that included the replacement PB is included in the slot list corresponding to index three, the memory system may update the slot lists such that the current VB is included in the slot list corresponding to index one (e.g., the current VB now includes one bad PB after swapping) and the VB that included the replacement PB is included in the slot list corresponding to index four (e.g., the VB now includes four bad PBs after swapping).

At 355, the memory system may identify whether more planes are available in a current VB. In some cases, if the memory system identifies that more planes are available in the current VB, the memory system may return to operation 325 (e.g., scanning through the planes of a VB and replacing non-limiting plane bad PBs according to operations 325 through 355). Alternatively, if the memory system identifies that no more planes are available in the current VB (e.g., the last PB of the VB has been analyzed), the memory system may move to operation 360.

At 360, the memory system may identify whether the current VB is included in the slot list corresponding to index one (e.g., Slot_1). If the memory system identifies that the current VB is included in the slot list corresponding to index one, the memory system may move to operation 365. Alternatively, if the current VB is included in a slot list corresponding to a different index (e.g., Slot_0, Slot _2, Slot_3, etc.), the memory system may move to operation 370.

At 365, the memory system may move the current VB to a slot list reserved for ICSs (e.g., Slot_ICS) including one bad PB at the limiting plane. In some examples, the memory system may move the current VB to the reserved slot list based on the VB being included in the slot list corresponding to index one after analyzing the VB and performing replacements.

At 370, the memory system may identify whether more VBs are included in the current slot list index. If the memory system identifies that more VBs are included in the current slot list index, the memory system may return to operation 320 (e.g., determining a next VB for analysis according to operations 320 through 370). Alternatively, if the memory system identifies that no more VBs are included in the current slot list index, the memory system may move to operation 375.

At 375, the memory system may set the current slot list index to a next non-empty slot. In some cases, the memory system may return to operation 315, and may analyze VBs in subsequent slot list indices according to operations 315 through 370 (or terminating the flowchart 300 if no more VBs are available for analysis).

Such techniques may support the memory system consolidating bad PBs into a relatively small quantity of VBs. That is, by performing the operations of the flowchart 300, the memory system may maximize a quantity of CSs (e.g., VBs including no bad PBs natively or after replacements) and a quantity of ICSs (e.g., VBs include one bad PB at the limiting plane natively or after replacements) present across the one or more memory dies, which may support the memory system synthesizing a BBT with a reduced size.

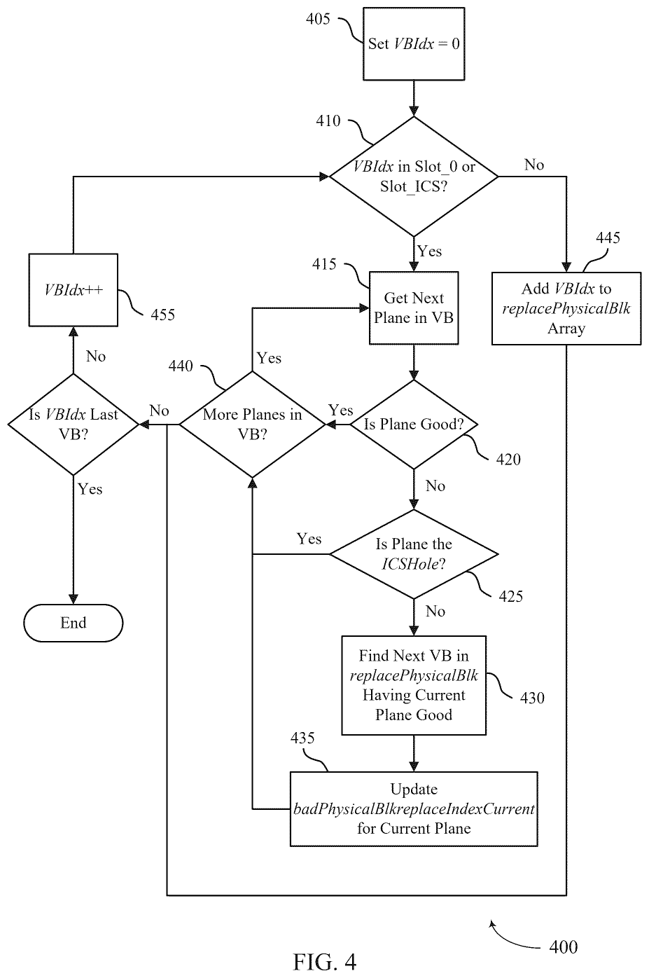

FIG. 4 shows an example of a flowchart 400 that supports ICS techniques in accordance with examples as disclosed herein. The flowchart 400 may implement, or be implemented by, one or more aspects of the system 100 and the flowcharts 200 and 300. For example, the flowchart 400 may illustrate an example of operations performed by a memory system, such as a memory system 110 described with reference to FIG. 1, to synthesize a BBT based on organizing PBs and performing bad PB replacements, which may be examples of corresponding operations performed with reference to FIGS. 2 and 3. In some cases, the flowchart 400 may support the memory system generating a BBT to store replacement mappings for PBs within the memory system. Alternative examples of the following may be implemented, where some steps are performed in a different order or not at all. Additionally, some steps may include additional features not mentioned below.

At 405, the memory system may set a VB index to zero (e.g., VBIdx=0), which may correspond to a first VB of the memory system.

At 410, the memory system may determine whether the current VB index corresponds to a VB included in a slot list corresponding to index zero (e.g., Slot_0 indicating that the VB is a CS) or an index reserved for ICSs (e.g., Slot_ICS indicating that the VB is an ICS including one bad PB at a limiting plane). In some cases, if the memory system determines that the VB is included in the Slot_0 or the Slot_ICS, the memory system may move to operation 415.

At 415, the memory system may identify a next plane in the current VB (e.g., a PB corresponding to the current VB and the identified plane).

At 420, the memory system may identify whether the PB corresponding to the identified VB and identified plane is ‘good’. In some examples, if the memory system determines that the PB is bad, the memory system may move to operation 425. Alternatively, if the memory system determines that the PB is good, the memory system may move to operation 440.

At 425, the memory system may identify whether the current plane is the limiting plane (e.g., the ICSHole) based on identifying that the current PB is bad. In some examples, if the memory system determines that the plane is not the limiting plane, the memory system may move to operation 430. Alternatively, if the memory system determines that the plane is the limiting plane, the memory system may move to operation 440 (e.g., the memory system may skip bad PBs in the limiting plane due to no replacements occurring within the limiting plane).

At 430, the memory system may identify a VB in an array of replacement blocks (e.g., a replacePhysicalBlk array), which may include VBs having at least one bad PB in a non-limiting plane. In some cases, the memory system may identify the next VB (e.g., according to index) of the replacement blocks that has a good PB at the current plane.

At 435, the memory system may update a mapping for the current plane (e.g., update the BBT mapping for badPhysicalBlkreplaceIndexCurrent) based on identifying the VB of the replacement blocks.

At 440, the memory system may identify whether more planes are available to analyze in the current VB. In some cases, if the memory system identifies that the current VB includes more planes, the memory system may return to operation 415 and perform operations 415 through 440 to analyze each plane (e.g., PB) of the current VB. Alternatively, if the memory system identifies that the current VB does not include more planes, the memory system may move to operation 450.

Alternatively, at 410, the memory system may determine that a current VB is not included in either of the Slot_0 or the Slot_ICS, and may move to operation 445. At 445, the memory system may add the current VB index to the array of replacement blocks (e.g., VBIdx is added to the replacePhysicalBlk array), which may include VBs that the memory system consolidated bad PBs to according to techniques described with reference to FIG. 3.

At 450, the memory system may determine whether the current VB is the last VB of the memory system. In some cases, the memory system may make the determination based on finishing analyzing a VB (e.g., if the VB is a CS or ICS) or adding a VB to the replacement block array (e.g., if the VB includes multiple bad PBs after replacement). If the memory system determines that the current VB is the last VB (e.g., the highest VBIdx), the memory system may terminate the flowchart 400. Alternatively, if the memory system identifies that more VBs are available in the memory system, the memory system may move to operation 455.

At 455, the memory system may increment the current VB index (e.g., increase by one). In some cases, the memory system may return to operation 410 and perform the operations of the flowchart 400 according to the update VB index.

Such techniques may support the memory system synthesizing a BBT with a reduced size (e.g., less than or equal to 16 KB), which may improve a performance of the memory system. For example, by performing the operations of the flowchart 400, the memory system may compress the LRT into a compact (e.g., smaller) BBT due to not including the CSs and ICSs in the BBT (e.g., BBT size corresponds to Total_Blocks_per_plane—Num_CS—Num_ICS, where Num_CS and Num_ICS may be inversely proportional). Further, by reducing the size of the BBT, the memory system may improve storage utilization, such as SRAM utilization (e.g., due to the BBT being retained in SRAM during low power modes) and NAND space utilization (e.g., used to store the BBT during power cycles).

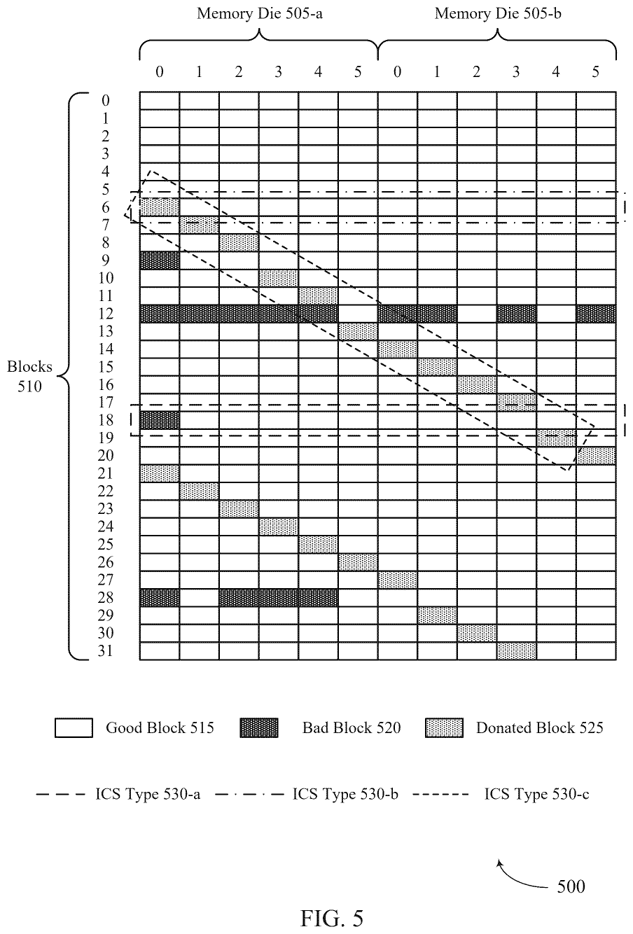

FIG. 5 shows an example of a memory array 500 that supports ICS techniques in accordance with examples as disclosed herein. The memory array 500 may implement, or be implemented by, one or more aspects of the system 100, as well as the flowcharts 200, 300, and 400. For example, the memory array 500 may be an example of memory cells included in one or more memory dies 505 (e.g., a memory die 505-a and a memory die 505-b) of a memory system, such as a memory system 110 described with reference to FIG. 1. Additionally, or alternatively, the memory array 500 may support the memory system accessing data associated with one or more CSs and ICSs according to a BBT, which may be examples of CSs and ICSs and the BBT generated according to operations described with respect to FIGS. 2 through 4. For example, the memory array 500 may be an example of a configuration of PBs after performing a block replacement procedure and synthesizing a BBT. In some examples, the memory array 500 may support the memory system generating a table, such as a low level physical to physical (LLP2P) table, to determine how to access data from the memory array 500.

The memory array 500 may include a memory die 505-a and a memory die 505-b, which may be associated with respective sets of memory cells of the memory array 500. In some examples, each memory die 505 may be associated with a respective set of planes of the memory array 500. For example, the memory die 505-a may be associated with a first set of planes of the memory array 500 (e.g., a first six planes, which may be planes 0 through 5 of the memory array 500) and the memory die 505-b may be associated with a second set of planes of the memory array 500 (e.g., a second six planes, which may be planes 6 through 11 of the memory array 500).

In some examples, each plane of the memory array 500 may be associated with a respective quantity of PBs of the memory array 500 (e.g., thirty-two PBs). For example, the memory system may identify a set of blocks 510, where each block (which may be referred to as a VB, a superblock, or both) of the set of blocks 510 may correspond to a set of PBs associated with each respective plane of the memory array 500. In the example illustrated by the memory array 500, the memory system may identify thirty-two blocks (e.g., VBs or superblocks) in the set of blocks 510 and twelve PBs (e.g., corresponding to the twelve planes across the memory die 505-a and the memory die 505-b) associated with each block of the set of blocks 510. In some cases, each block of the set of blocks 510 may be associated with a respective index (e.g., a NAND block index).

In some cases, the memory array 500 may include one or more types of PBs, such as one or more good blocks 515 (e.g., ‘good’ PBs), one or more bad blocks 520 (e.g., ‘bad’ PBs), or both. The memory system may identify whether each block of the set of blocks 510 is a CS (e.g., a VB or superblock including good blocks 515 across each plane of the memory array 500), an ICS (e.g., a VB or superblock including a single bad block 520 at a limiting plane of the memory array 500), or a replacement block (e.g., a VB or superblock including at least one bad block 520 at a non-limiting plane of the memory array 500) according to the types of PBs included in each block. In the example illustrated by the memory array 500, the memory system may identify that blocks zero through eight, ten, eleven, thirteen through seventeen, nineteen through twenty-seven, and twenty-nine through thirty-one are CSs, blocks nine and eighteen are ICSs, and blocks twelve and twenty-eight are replacement blocks.

The memory system may generate a table, such as a LLP2P table, according to the type of each block of the set of blocks 510. In some cases, the memory system may first include NAND block indices corresponding to CSs in the LLP2P table (e.g., starting from NAND block index zero). In the example illustrated by the memory array 500, the memory array may include the first nine blocks (e.g., block indices zero through eight) in the first nine entries of the LLP2P table, may refrain from adding the block corresponding to index nine (e.g., an ICS) at a tenth entry of the LLP2P table, and may instead include the block corresponding to index ten (e.g., a CS) at the tenth entry. Additionally, the memory system may refrain from including replacement blocks in the LLP2P table. That is, the memory system may skip NAND block indices corresponding to native ICSs (e.g., VBs in Slot_ICS as described with reference to FIG. 3) and bad block replacement blocks (e.g., VBs not in Slot_0 or Slot_ICS) if generating the LLP2P table.

In some cases, the memory system may continue to include blocks corresponding to CSs first in the LLP2P table and may append blocks corresponding to ICSs at an end of the LLP2P table (e.g., mapping each native ICS to an incremental LLP index starting from the last CS LLP index+1 once each CS is mapped). For example, in accordance with the memory array 500, the memory system may generate an LLP2P table corresponding to Table 1 below:

TABLE 1

| LLP Index | NAND Block Index |
|---|---|
| 0 | 0 |
| 1 | 1 |
| 2 | 2 |
| . . . | . . . |
| 8 | 8 |
| 9 | 10 |
| 10 | 11 |
| 11 | 13 |
| 12 | 14 |
| 13 | 15 |
| . . . | . . . |
| 26 | 30 |
| 27 | 31 |
| 28 | 9 |
| 29 | 18 |

In some cases, the memory system may identify or generate one or more types of superblocks in the memory array 500 based on the LLP2P table. In some examples, the memory system may designate a first quantity of CSs (e.g., a first N₀ NAND block indices in the LLP2P table) to remain as CSs. For example, the memory array may retain the first six blocks of the memory array (e.g., NAND block indices zero through five) as CSs and may use these blocks for various purposes, such as firmware operations, BBT storage, system block operations, or any combination thereof, among other examples.

In some examples, the memory system may dedicate (e.g., designate) a PB from each CS of the LLP2P table after the first quantity of CSs to be a donated block 525. For example, the memory system may identify a PB of each of the NAND blocks corresponding to a second quantity of CSs in the LLP2P table (e.g., N, NAND block indices after the first No NAND block indices) to be a donated block 525. In some cases, the memory system may dedicate the donated blocks 525 of the second quantity of CSs according to a diagonal configuration. For example, the memory system may designate a PB of the NAND block index six at plane zero of the memory die 505-a as a first donated block 525, may designate a PB of the NAND block index seven at plane one of the memory die 505-a as a second donated block 525, and so on in accordance with the order of the second quantity of CSs in an order of the LLP2P table as illustrated by the memory array 500 (e.g., refraining from dedicating any PBs as donated blocks 525 from native ICSs included at the end the of LLP2P table or replacement blocks not included in the LLP2P table).

In some cases, such techniques may support the memory system identifying one or more types of superblocks, such as ICSs having one or more ICS types 530. For example, the memory system may identify one or more ICSs having an ICS type 530-a, which may indicate an ICS that includes a bad block 520 in a limiting plane of the memory array 500 and does not include a donated block 525 (e.g., a native ICS, such as the NAND block index eighteen with reference to FIG. 5). Additionally, or alternatively, the memory system may identify one or more ICSs having an ICS type 530-b, which may indicate ICSs that are formed from designating a donated block 525 from a CS (e.g., horizontal ICSs created from a CS and associated with a single NAND block index, such as the NAND block index six with reference to FIG. 5). Additionally, or alternatively, the memory system may identify one or more ICSs having an ICS type 530-c, which may indicate ICSs including donated blocks 525 from multiple CSs (e.g., diagonal ICSs including donated blocks 525 from all but one plane of the memory array 500).

In the example illustrated by the memory array 500, the memory system may identify a first ICS having the ICS type 530-c that includes donated blocks 525 corresponding to planes zero through eleven of the memory array 500 (e.g., across planes zero through six of the memory die 505-a and planes zero through five of the memory die 505-b) and a second ICS having the ICS type 530-c that includes donated blocks 525 corresponding to plane twelve and planes zero through ten of the memory array 500.

In some examples, the memory system may identify the type of a superblock according to a range of an LLP index (e.g., LLPidx) of the superblock within the LLP2P table. For example, the memory system may identify that a superblock is a CS if the LLP index is within a first range of LLP indices (e.g., LLPidx<N₀, due to the first N₀ CSs remaining as CSs). Additionally, the memory system may identify that a superblock is an ICS having the ICS type 520-b if the LLP index is within a second range of LLP indices (e.g., N_{S1}≤LLPidx<N_{S1}+N₁, where N_{S1}=N₀ and N₁ corresponds to the quantity of CSs including a donated block 525).

Additionally, memory system may identify that a superblock is an ICS having the ICS type 520-a if the LLP index is within a third range of LLP indices (e.g., N_{S2}≤LLPidx<N_{S2}+N₂, where N_{S2}=N_{S1}+N₁ and N₂ corresponds to the quantity of native ICSs included at the end of the LLP2P table). Additionally, the memory system may identify that a superblock is an ICS having the ICS type 520-c if the LLP index is within a third range of LLP indices (e.g., LLPidx≥N_{S3}, where N_{S3}=N_{S2}+N₂). That is, the memory system may map the ICSs having ICS type 520-c (e.g., diagonal ICSs) using consecutive LLP indices starting from a last native ICS LLP2P index plus one (e.g., the first diagonal ICS may have an LLP index of thirty according to Table 1).

In some examples, generating the LLP2P table and identifying the various types of superblocks (e.g., the first N₀ CSs and the one or more ICS types 530) may support the memory system accessing data stored in the memory array 500. For example, the memory system may determine a NAND block index (e.g., Blk_{idx}) and bad plane index (e.g., the plane including a bad block 520, which may be represented by BadPlane_{idx}) of an ICS mathematically (e.g., dynamically according to a function, equation, algorithm, or the like). That is, the memory system may identify what blocks are associated with an ICS according to the LLP index of the ICS and a formula associated with the type of the ICS (e.g., identified according to the location of the LLP index within a range of the LLP2P table).

As a first example, for an ICS having the ICS type 530-a (e.g., a native ICS), the memory system may identify a NAND block index and a bad plane index according to equations 1 and 2 below:

$$B l {k}_{i d x} = L L P 2 P ( L L {P}_{i d x} ) \qquad ( 1 )$$

$$BadP l a n {e}_{i d x} = l i m i t i n g P l a n {e}_{i d x} \qquad ( 2 )$$

As such, the memory system may identify that an ICS having the ICS type 530-a corresponds to a NAND block index associated with the current LLP index (e.g., the LLP index twenty-nine indicates the NAND block index eighteen according to Table 1) and that the bad plane of the ICS corresponds to the limiting plane (e.g., due to the ICS being a native ICS of ICS type 530-a).

As a second example, for an ICS having the ICS type 530-b (e.g., a horizontal ICS formed from dedicating a donated block 525 from a CS), the memory system may identify the NAND block index and the bad plane index for the ICS according to equations 3 and 4 below:

$$B l {k}_{i d x} = L L P 2 P ( L L {P}_{i d x} ) \qquad ( 3 )$$

$$BadP l a n {e}_{i d x} = ( L L {P}_{i d x} - {N}_{0} ) \% {N}_{p} \qquad ( 4 )$$

As such, the memory system may identify that an ICS having the ICS type 530-bcorresponds to a NAND block index associated with the current LLP index (e.g., the LLP index six indicates the NAND block index six according to Table 1) and that the bad plane of the ICS corresponds to a donated block 525 at the NAND block index. For example, a plane associated with the donated block 525 may determined according to equation 4 (e.g., due to the diagonal configuration of the donated blocks 525), where Np may correspond to the total quantity of planes of the memory array 500 (e.g., twelve planes).

As a third example, for an ICS having the ICS type 530-c (e.g., a diagonal ICS including donated blocks 525 from multiple NAND block indices), the memory system may identify the NAND block index and the bad plane index for the ICS according to equations 5 and 6 below:

$$B l {k}_{i d x} ( {Plane}_{i d x} ) = L L P 2 P ( ( {Plane}_{i d x} - {P}_{S} ) \% {N}_{p} + {B}_{S} ) \qquad ( 5 )$$

$$BadP l a n {e}_{i d x} = ( {P}_{S} + {N}_{p} - 1 ) \% {N}_{p} \qquad ( 6 )$$

As such, the memory system may identify that an ICS having the ICS type 530-c corresponds to a NAND block index based on a current plane index Plane_{idx} (e.g., due to multiple NAND block indices being associated with the ICS type 530-c), a starting plane index for the ICS Pₛ (e.g., P_{S}=Plane_{idx_start}), and an offset value Bₛ. For example, the memory system may identify the starting plane index, P_{S}, according to Pₛ=Plane_{idx_start}=((LLP_{idx}−N_{S3})*(N_{P}−1)) % N_{P}. Additionally, the memory system may identify the offset value, Bₛ, according to B_{S}=(N₀+(LLP_{idx}−N_{S3})*(N_{P}−1)). In some examples, the memory system may identify the bad plane of the ICS according to the starting plane index, P_{S}, and the total quantity of planes in the memory array 500, N_{P}.

In some examples, such techniques may support improved access operations and storage utilization by the memory system. For example, by accessing data dynamically according to the ICS types 530 and the associated functions (e.g., instead of using BBT mappings for each PB), latency associated with accessing data in the memory array 500 may be reduced while also reducing a size of the BBT, thereby improving storage utilization at a portion of memory used to store the BBT (e.g., RAM, SRAM, or the like). Additionally, the memory system may support backwards compatibility with existing BBT management schemes, for example by managing the LLP2P table and mathematical formulas to access ICS blocks within a flash translation layer (FTL) (e.g., before accessing a standard BBT for block management).

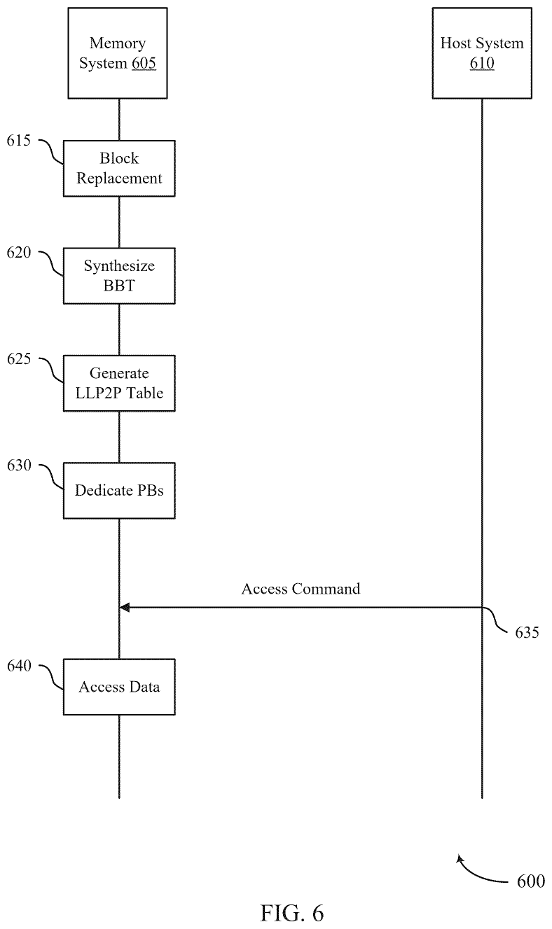

FIG. 6 shows an example of a process 600 that supports ICS techniques in accordance with examples as disclosed herein. The process 600 may implement, or be implemented by, one or more aspects of the system 100, the flowcharts 200 through 400, and the memory array 500. For example, the process 600 may illustrate operations performed by a memory system 605 and a host system 610, which may be examples of corresponding aspects described with reference to FIG. 1. Additionally, the process 600 may support the memory system 605 accessing data from a memory array based on performing block replacements, synthesizing a BBT, and dedicating PBs to form one or more types of ICSs in accordance with operations and techniques described with reference to FIGS. 2 through 5. Alternative examples of the following may be implemented, where some steps are performed in a different order or not at all. Additionally, some steps may include additional features not mentioned below.

At 615, one or more block replacement procedures may be formed. For example, the memory system 605 may perform one or more block replacement procedures on PBs of a memory array (e.g., in accordance with operations performed with reference to FIGS. 2 and 3). In some cases, to support the block replacement procedures, the memory system 605 may initialize a LRT, a bad block bitmap, and a set of slot lists. The memory system 605 may scan all of the PBs of the memory array to identify bad PBs and may indicate the status of each PB according to a corresponding bit in the bad block bitmap. Additionally, or alternatively, the memory system 605 may categorize VBs (e.g., associated with a set of PBs across each respective plane of the memory array) into a slot list of the set of slot lists according to a quantity of bad PBs associated with each VB.

In some examples, the memory system 605 may perform the one or more block replacement procedures to consolidate bad PBs into one or more replacement blocks (e.g., VBs used to store multiple bad PBs and included in a BBT). In some cases, the memory system 605 may refrain from replacing bad PBs that are associated with a limiting plane of the memory array (e.g., a plane associated with a greatest quantity of bad PBs across each VB of the memory array). For example, the memory system 605 may replace bad PBs in non-limiting planes of a VB with good PBs of a VB included in a higher slot list index (e.g., as described with reference to FIG. 3) and may refrain from replacing an bad PB of the VB that is associated with the limiting plane of the memory array. In some cases, the memory system 605 may store replacement mappings for the replacement procedures in the LRT. In some cases, such techniques may maximize a quantity of CSs (e.g., a VB including a full complement of good PBs) and ICSs (e.g., a VB including a single bad PB at the limiting planc) in the memory array.

At 620, a BBT may be synthesized. In some examples, the memory system 605 may synthesize (e.g., generate) a BBT based on performing the block replacement procedures (e.g., in accordance with operations performed with reference to FIG. 4), which may include a set of multiple mappings indicating associations between logical addresses and physical addresses of replaced PBs. For example, the memory system 605 may compress the LRT into the BBT (e.g., a more compact data structure) by including replacement blocks in the BBT (e.g., a VB is included in the BBT if the VB is not included in Slot_0 or Slot_ICS) and refraining from including CSs and ICSs in the BBT. In some cases, the memory system 605 may generate the BBT having a size below a target threshold (e.g., a target maximum of 16 KB for eight memory dies each including six planes), which may reduce a storage impact of the BBT (e.g., the BBT may use less RAM space during low power modes or less NAND space during power cycles).

At 625, a LLP2P table may be generated. In some examples, the memory system 605 may generate a LLP2P table to support accessing data stored to the memory array (e.g., in accordance with techniques described with reference to FIG. 5), which may include a set of multiple mappings between VBs of the memory array and LLP2P indices. In some cases, the memory system 605 may scan through the VBs of the memory array (e.g., after performing replacements and generating the BBT) and may include VBs in the LLP2P table according to a type of superblock associated with each VB. As an example, the memory system 605 may include a first superblock and another superblock (which may be referred to as a third superblock) in a first set of mappings (e.g., a first set of indices of the LLP2P table) based on the first superblock and the other superblock being CSs after replacement (e.g., the first set of mappings correspond to one or more CSs). Additionally, the memory system 605 may include a fourth superblock of the memory array in a second set of mappings (e.g., a second set of indices of the LLP2P table after the first set of indices) based on the fourth superblock being an ICS after replacement (e.g., the second set of mappings correspond to one or more ICSs). In some cases, the memory system 605 may refrain from including replacement blocks in the LLP2P table.

At 630, one or more PBs may be designated. In some examples, the memory system 605 may dedicate one or more PBs from one or more superblocks (e.g., VBs) of the memory array to form one or more ICSs (e.g., diagonal ICSs). For example, the memory system 605 may dedicate a first PB of a first superblock of the memory system to be part of a second superblock and may dedicate a second PB of a third superblock to be part of the second superblock. In some examples, the first PB may correspond to a first plane of the memory array and the second PB may correspond to a second plane of the memory array that is different than the first plane (e.g., forming a diagonal ICS). In some cases, each of the first superblock and the second superblock may include a full complement of good PBs prior to dedicating the PBs to the second superblock (e.g., the first superblock and the second superblock may be horizontal CSs prior to dedicating PBs).

In some cases, the memory system 605 may identify one or more types of ICSs based on dedicating the one or more PBs. For example, the memory system 605 may identify that the first superblock is a first type of ICS based on dedicating the first PB, may identify that the third superblock is the first type of ICS based on dedicating the second PB, and may identify that the second superblock is a second type of ICS based on dedicating the first PB and the second PB. Additionally, the memory system 605 may identify that the fourth superblock is a third type of ICS, and may refrain from dedicating any PBs associated with the fourth superblock based on the fourth superblock being the third type of ICS. In some cases, the first type of ICS may include multiple PBs that are each associated with a single superblock of the memory array (e.g., a horizontal ICS associated with the same NAND block index), the second type of ICS may include multiple PBs that are each associated with a different superblock of the memory array (e.g., a diagonal ICS associated with multiple NAND block indices), and the third type of ICS may indicate an ICS formed after performing replacements (e.g., a native ICS associated with a single NAND block index).

In some examples, the memory system 605 may refrain from dedicating PBs from a first quantity of CSs included in the LLP2P table. For example, a first subset the first set of mappings in the LLP2P table may correspond to a first subset superblocks of the memory array based on respective indices associated with the first subset of superblocks (e.g., an initial No superblocks that will remain as CSs to support firmware operations, BBT storage, system block operations, or the like) and a second subset of the first set of mappings may include at least the first superblock and the third superblock based on a first index associated with the first superblock and a second index associated with the second superblock being greater than each of the respective indices associated with the first subset of superblocks.

At 635, an access command may be received. In some examples, the memory system 605 may receive an access command from the host system 610. In some cases, the access command may indicate data to be read from the memory array.

At 640, data stored in the memory array may be accessed. In some examples, the memory system 605 may access data stored in the memory array based on receiving the access command and dedicating the PBs. For example, the memory system 605 may access data associated with the first superblock, the second superblock, the third superblock, or any combination thereof based on dedicating the first PB and the second PB. In some cases, the memory system 605 may access data dynamically according to one or more functions based on a type of superblock associated with the data (e.g., in accordance with techniques described with reference to FIG. 5). For example, the memory system 605 may access, dynamically, first data associated with the first superblock and second data associated with the third superblock in accordance with a first function based on the first superblock and the third superblock being the first type of ICS. Additionally, the memory system 605 may access, dynamically, third data associated with the second superblock in accordance with a second function based on the second superblock being the second type of ICS. Additionally, the memory system 605 may access, dynamically, fourth data associated with the fourth superblock in accordance with a third function based on the fourth superblock being the third type of ICS.

Such techniques may support the memory system 605 consolidating bad PBs into a relatively small quantity of superblocks and dynamically accessing data to reduce a size of the BBT, thereby improving storage utilization and access operations by the memory system 605.

Aspects of the process 600 may be implemented by one or more controllers, among other components. Additionally, or alternatively, aspects of the process 600 may be implemented as instructions stored in one or more memories (e.g., firmware stored in one or more memories coupled with the memory system 110. For example, the instructions, when executed by one or more controllers (e.g., the memory system controller 115), may cause the one or more controllers (or a device or a system) to perform the operations of the process 600.

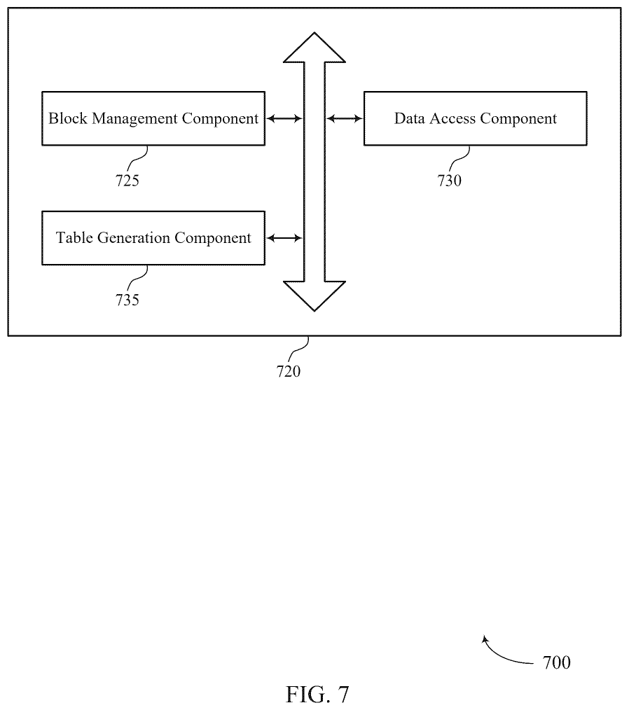

FIG. 7 shows a block diagram 700 of a memory system 720 that supports ICS techniques in accordance with examples as disclosed herein. The memory system 720 may be an example of aspects of a memory system as described with reference to FIGS. 1 through 6. The memory system 720, or various components thereof, may be an example of means for performing various aspects of ICS techniques as described herein. For example, the memory system 720 may include a block management component 725, a data access component 730, a table generation component 735, or any combination thereof. Each of these components, or components of subcomponents thereof (e.g., one or more processors, one or more memories), may communicate, directly or indirectly, with one another (e.g., via one or more buses).

The block management component 725 may be configured as or otherwise support a means for dedicating a first physical block of a first superblock of a plurality of superblocks to a second superblock of the plurality of superblocks. In some examples, the block management component 725 may be configured as or otherwise support a means for dedicating a second physical block of a third superblock of the plurality of superblocks to the second superblock, where each of the first superblock and a third superblock include a full complement of good physical blocks prior to dedicating physical blocks to the second superblock. The data access component 730 may be configured as or otherwise support a means for accessing data associated with the first superblock, the second superblock, the third superblock, or any combination thereof based at least in part on dedicating the first physical block and the second physical block to the second superblock.

In some examples, the first superblock includes a first type of ICS based at least in part on dedicating the first physical block; the second superblock includes a second type of ICS based at least in part on dedicating the first physical block and the second physical block; and the third superblock includes the first type of ICS based at least in part on dedicating the second physical block.

In some examples, the first type of ICS includes a plurality of physical blocks that are each associated with a single superblock of the plurality of superblocks; and the second type of ICS includes a plurality of physical blocks that are each associated with a different superblock of the plurality of superblocks.

In some examples, to support accessing the data associated with the first superblock, the second superblock, the third superblock, or any combination thereof, the data access component 730 may be configured as or otherwise support a means for accessing, dynamically, first data associated with the first superblock and second data associated with the third superblock in accordance with a first function based at least in part on the first superblock and the third superblock including the first type of ICS. In some examples, to support accessing the data associated with the first superblock, the second superblock, the third superblock, or any combination thereof, the data access component 730 may be configured as or otherwise support a means for accessing, dynamically, third data associated with the second superblock in accordance with a second function based at least in part on the second superblock including the second type of ICS.

In some examples, a fourth superblock of the plurality of superblocks includes a third type of ICS, and the block management component 725 may be configured as or otherwise support a means for refraining from dedicating any physical blocks associated with the fourth superblock to the second superblock based at least in part on the fourth superblock including the third type of ICS. In some examples, a fourth superblock of the plurality of superblocks includes a third type of ICS, and the data access component 730 may be configured as or otherwise support a means for accessing, dynamically, fourth data associated with the fourth superblock in accordance with a third function based at least in part on the fourth superblock including the third type of ICS.

In some examples, the first physical block corresponds to a first plane of one or more planes and the second physical block corresponds to a second plane of the one or more planes that is different than the first plane.

In some examples, the table generation component 735 may be configured as or otherwise support a means for generating a first plurality of mappings based at least in part on identifying the plurality of superblocks, where accessing the data associated with the first superblock, the second superblock, the third superblock, or any combination thereof is based at least in part on generating the first plurality of mappings.

In some examples, a first set of the first plurality of mappings correspond to one or more complete superblocks of the plurality of superblocks; and a second set of the first plurality of mappings correspond to a plurality of ICSs of the plurality of superblocks.

In some examples, to support generating the first plurality of mappings, the table generation component 735 may be configured as or otherwise support a means for including the first superblock and the third superblock in the first set of the first plurality of mappings based at least in part on the first superblock being a complete superblock prior to dedicating the first physical block to the second superblock and the third superblock being a complete superblock prior to dedicating the second physical block to the second superblock. In some examples, to support generating the first plurality of mappings, the table generation component 735 may be configured as or otherwise support a means for including a fourth superblock of the plurality of superblocks in the second set of the first plurality of mappings based at least in part on the fourth superblock being an ICS.

In some examples, a first subset of the first set of the first plurality of mappings correspond to a first subset of superblocks of the plurality of superblocks based at least in part on respective indices associated with the first subset of superblocks of the plurality of superblocks; and a second subset of the first set of the first plurality of mappings include at least the first superblock and the third superblock based at least in part on a first index associated with the first superblock and a second index associated with the third superblock being greater than each of the respective indices associated with the first subset of superblocks of the plurality of superblocks.

In some examples, the block management component 725 may be configured as or otherwise support a means for replacing at least one physical block of the first superblock, the third superblock, or both before dedicating the first physical block and the second physical block to the second superblock.

In some examples, the table generation component 735 may be configured as or otherwise support a means for generating a second plurality of mappings based at least in part on replacing the at least one physical block of the first superblock, the third superblock, or both, where the second plurality of mappings includes associations between logical addresses and physical addresses of respective physical blocks of the first superblock, the second superblock, and the third superblock.

In some examples, the described functionality of the memory system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 720, or various components thereof, may be implemented at least in part by instructions (e.g., stored in memory, non-transitory computer-readable medium) executable by such at least one processor.

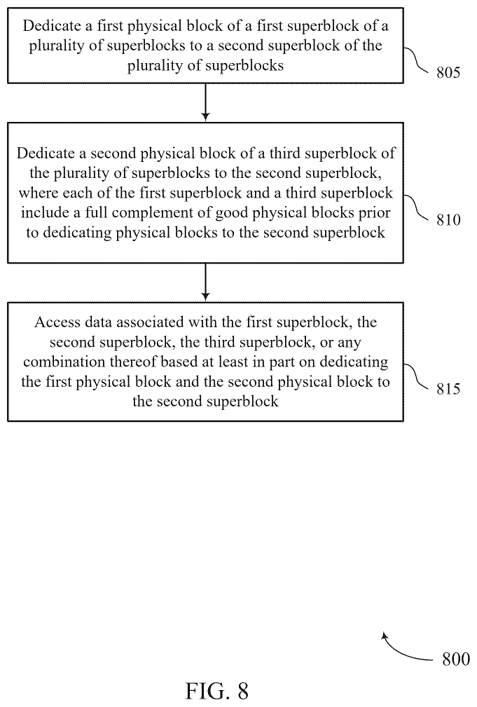

FIG. 8 shows a flowchart illustrating a method 800 that supports ICS techniques in accordance with examples as disclosed herein. The operations of method 800 may be implemented by a memory system or its components as described herein. For example, the operations of method 800 may be performed by a memory system as described with reference to FIGS. 1 through 7. In some examples, a memory system may execute a set of instructions to control the functional elements of the device to perform the described functions. Additionally, or alternatively, the memory system may perform aspects of the described functions using special-purpose hardware.

At 805, the method may include dedicating a first physical block of a first superblock of a plurality of superblocks to a second superblock of the plurality of superblocks. In some examples, aspects of the operations of 805 may be performed by a block management component 725 as described with reference to FIG. 7.

At 810, the method may include dedicating a second physical block of a third superblock of the plurality of superblocks to the second superblock, where each of the first superblock and a third superblock include a full complement of good physical blocks prior to dedicating physical blocks to the second superblock. In some examples, aspects of the operations of 810 may be performed by a block management component 725 as described with reference to FIG. 7.

At 815, the method may include accessing data associated with the first superblock, the second superblock, the third superblock, or any combination thereof based at least in part on dedicating the first physical block and the second physical block to the second superblock. In some examples, aspects of the operations of 815 may be performed by a data access component 730 as described with reference to FIG. 7.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for dedicating a first physical block of a first superblock of a plurality of superblocks to a second superblock of the plurality of superblocks; dedicating a second physical block of a third superblock of the plurality of superblocks to the second superblock, where each of the first superblock and a third superblock include a full complement of good physical blocks prior to dedicating physical blocks to the second superblock; and accessing data associated with the first superblock, the second superblock, the third superblock, or any combination thereof based at least in part on dedicating the first physical block and the second physical block to the second superblock.

Aspect 2: The method, apparatus, or non-transitory computer-readable medium of aspect 1, where the first superblock includes a first type of ICS based at least in part on dedicating the first physical block; the second superblock includes a second type of ICS based at least in part on dedicating the first physical block and the second physical block; and the third superblock includes the first type of ICS based at least in part on dedicating the second physical block.

Aspect 3: The method, apparatus, or non-transitory computer-readable medium of aspect 2, where the first type of ICS includes a plurality of physical blocks that are each associated with a single superblock of the plurality of superblocks; and the second type of ICS includes a plurality of physical blocks that are each associated with a different superblock of the plurality of superblocks.

Aspect 4: The method, apparatus, or non-transitory computer-readable medium of any of aspects 2 through 3, where accessing the data associated with the first superblock, the second superblock, the third superblock, or any combination thereof includes operations, features, circuitry, logic, means, or instructions, or any combination thereof for accessing, dynamically, first data associated with the first superblock and second data associated with the third superblock in accordance with a first function based at least in part on the first superblock and the third superblock including the first type of ICS and accessing, dynamically, third data associated with the second superblock in accordance with a second function based at least in part on the second superblock including the second type of ICS.

Aspect 5: The method, apparatus, or non-transitory computer-readable medium of any of aspects 1 through 4, where a fourth superblock of the plurality of superblocks includes a third type of ICS and the method, apparatuses, and non-transitory computer-readable medium further includes operations, features, circuitry, logic, means, or instructions, or any combination thereof for refraining from dedicating any physical blocks associated with the fourth superblock to the second superblock based at least in part on the fourth superblock including the third type of ICS and accessing, dynamically, fourth data associated with the fourth superblock in accordance with a third function based at least in part on the fourth superblock including the third type of ICS.

Aspect 6: The method, apparatus, or non-transitory computer-readable medium of any of aspects 1 through 5, where the first physical block corresponds to a first plane of one or more planes and the second physical block corresponds to a second plane of the one or more planes that is different than the first plane.

Aspect 7: The method, apparatus, or non-transitory computer-readable medium of any of aspects 1 through 6, further including operations, features, circuitry, logic, means, or instructions, or any combination thereof for generating a first plurality of mappings based at least in part on identifying the plurality of superblocks, where accessing the data associated with the first superblock, the second superblock, the third superblock, or any combination thereof is based at least in part on generating the first plurality of mappings.

Aspect 8: The method, apparatus, or non-transitory computer-readable medium of aspect 7, where a first set of the first plurality of mappings correspond to one or more complete superblocks of the plurality of superblocks; and a second set of the first plurality of mappings correspond to a plurality of ICSs of the plurality of superblocks.

Aspect 9: The method, apparatus, or non-transitory computer-readable medium of aspect 8, where generating the first plurality of mappings includes operations, features, circuitry, logic, means, or instructions, or any combination thereof for including the first superblock and the third superblock in the first set of the first plurality of mappings based at least in part on the first superblock being a complete superblock prior to dedicating the first physical block to the second superblock and the third superblock being a complete superblock prior to dedicating the second physical block to the second superblock and including a fourth superblock of the plurality of superblocks in the second set of the first plurality of mappings based at least in part on the fourth superblock being an ICS.

Aspect 10: The method, apparatus, or non-transitory computer-readable medium of any of aspects 8 through 9, where a first subset of the first set of the first plurality of mappings correspond to a first subset of superblocks of the plurality of superblocks based at least in part on respective indices associated with the first subset of superblocks of the plurality of superblocks; and a second subset of the first set of the first plurality of mappings include at least the first superblock and the third superblock based at least in part on a first index associated with the first superblock and a second index associated with the third superblock being greater than each of the respective indices associated with the first subset of superblocks of the plurality of superblocks.

Aspect 11: The method, apparatus, or non-transitory computer-readable medium of any of aspects 1 through 10, further including operations, features, circuitry, logic, means, or instructions, or any combination thereof for replacing at least one physical block of the first superblock, the third superblock, or both before dedicating the first physical block and the second physical block to the second superblock.

Aspect 12: The method, apparatus, or non-transitory computer-readable medium of aspect 11, further including operations, features, circuitry, logic, means, or instructions, or any combination thereof for generating a second plurality of mappings based at least in part on replacing the at least one physical block of the first superblock, the third superblock, or both, where the second plurality of mappings includes associations between logical addresses and physical addresses of respective physical blocks of the first superblock, the second superblock, and the third superblock.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
dedicate a first physical block of a first superblock of a plurality of superblocks to a second superblock of the plurality of superblocks;
dedicate a second physical block of a third superblock of the plurality of superblocks to the second superblock, wherein each of the first superblock and the third superblock comprise a full complement of good physical blocks prior to dedicating physical blocks to the second superblock; and
access data associated with the first superblock, the second superblock, the third superblock, or any combination thereof based at least in part on dedicating the first physical block and the second physical block to the second superblock.

2. The memory system of claim 1, wherein:
the first superblock comprises a first type of incomplete superblock based at least in part on dedicating the first physical block;
the second superblock comprises a second type of incomplete superblock based at least in part on dedicating the first physical block and the second physical block; and
the third superblock comprises the first type of incomplete superblock based at least in part on dedicating the second physical block.

3. The memory system of claim 2, wherein:
the first type of incomplete superblock comprises a plurality of physical blocks that are each associated with a single superblock of the plurality of superblocks; and
the second type of incomplete superblock comprises a plurality of physical blocks that are each associated with a different superblock of the plurality of superblocks.

4. The memory system of claim 2, wherein, to access the data associated with the first superblock, the second superblock, the third superblock, or any combination thereof, the processing circuitry is configured to cause the memory system to:
access, dynamically, first data associate with the first superblock and second data associated with the third superblock in accordance with a first function based at least in part on the first superblock and the third superblock comprising the first type of incomplete superblock; and
access, dynamically, third data associate with the second superblock in accordance with a second function based at least in part on the second superblock comprising the second type of incomplete superblock.

5. The memory system of claim 1, wherein a fourth superblock of the plurality of superblocks comprises a third type of incomplete superblock, and the processing circuitry is further configured to cause the memory system to:
refrain from dedicating any physical blocks associated with the fourth superblock to the second superblock based at least in part on the fourth superblock comprising the third type of incomplete superblock; and
access, dynamically, fourth data associate with the fourth superblock in accordance with a third function based at least in part on the fourth superblock comprising the third type of incomplete superblock.

6. The memory system of claim 1, wherein the first physical block corresponds to a first plane of one or more planes and the second physical block corresponds to a second plane of the one or more planes that is different than the first plane.

7. The memory system of claim 1, wherein the processing circuitry is further configured to cause the memory system to:
generate a first plurality of mappings based at least in part on identifying the plurality of superblocks, wherein accessing the data associated with the first superblock, the second superblock, the third superblock, or any combination thereof is based at least in part on generating the first plurality of mappings.

8. The memory system of claim 7, wherein:
a first set of the first plurality of mappings correspond to one or more complete superblocks of the plurality of superblocks; and
a second set of the first plurality of mappings correspond to a plurality of incomplete superblocks of the plurality of superblocks.

9. The memory system of claim 8, wherein, to generate the first plurality of mappings, the processing circuitry is configured to cause the memory system to:
include the first superblock and the third superblock in the first set of the first plurality of mappings based at least in part on the first superblock being a complete superblock prior to dedicating the first physical block to the second superblock and the third superblock being a complete superblock prior to dedicating the second physical block to the second superblock; and
include a fourth superblock of the plurality of superblocks in the second set of the first plurality of mappings based at least in part on the fourth superblock being an incomplete superblock.

10. The memory system of claim 8, wherein:
a first subset of the first set of the first plurality of mappings correspond to a first subset of superblocks of the plurality of superblocks based at least in part on respective indices associated with the first subset of superblocks of the plurality of superblocks; and
a second subset of the first set of the first plurality of mappings comprise at least the first superblock and the third superblock based at least in part on a first index associated with the first superblock and a second index associated with the third superblock being greater than each of the respective indices associated with the first subset of superblocks of the plurality of superblocks.

11. The memory system of claim 1, wherein the processing circuitry is further configured to cause the memory system to:
replace at least one physical block of the first superblock, the third superblock, or both before dedicating the first physical block and the second physical block to the second superblock.

12. The memory system of claim 11, wherein the processing circuitry is further configured to cause the memory system to:
generate a second plurality of mappings based at least in part on replacing the at least one physical block of the first superblock, the third superblock, or both, wherein the second plurality of mappings comprises associations between logical addresses and physical addresses of respective physical blocks of the first superblock, the second superblock, and the third superblock.

13. A method by memory system, comprising:
dedicating a first physical block of a first superblock of a plurality of superblocks to a second superblock of the plurality of superblocks;
dedicating a second physical block of a third superblock of the plurality of superblocks to the second superblock, wherein each of the first superblock and a third superblock comprise a full complement of good physical blocks prior to dedicating physical blocks to the second superblock; and
accessing data associated with the first superblock, the second superblock, the third superblock, or any combination thereof based at least in part on dedicating the first physical block and the second physical block to the second superblock.

14. The method of claim 13, wherein:
the first superblock comprises a first type of incomplete superblock based at least in part on dedicating the first physical block;
the second superblock comprises a second type of incomplete superblock based at least in part on dedicating the first physical block and the second physical block; and
the third superblock comprises the first type of incomplete superblock based at least in part on dedicating the second physical block.

15. The method of claim 14, wherein:
the first type of incomplete superblock comprises a plurality of physical blocks that are each associated with a single superblock of the plurality of superblocks; and
the second type of incomplete superblock comprises a plurality of physical blocks that are each associated with a different superblock of the plurality of superblocks.

16. The method of claim 14, wherein accessing the data associated with the first superblock, the second superblock, the third superblock, or any combination thereof comprises:
accessing, dynamically, first data associated with the first superblock and second data associated with the third superblock in accordance with a first function based at least in part on the first superblock and the third superblock comprising the first type of incomplete superblock; and
accessing, dynamically, third data associated with the second superblock in accordance with a second function based at least in part on the second superblock comprising the second type of incomplete superblock.

17. The method of claim 13, wherein a fourth superblock of the plurality of superblocks comprises a third type of incomplete superblock, the method further comprising:
refraining from dedicating any physical blocks associated with the fourth superblock to the second superblock based at least in part on the fourth superblock comprising the third type of incomplete superblock; and
accessing, dynamically, fourth data associated with the fourth superblock in accordance with a third function based at least in part on the fourth superblock comprising the third type of incomplete superblock.

18. The method of claim 13, wherein the first physical block corresponds to a first plane of one or more planes and the second physical block corresponds to a second plane of the one or more planes that is different than the first plane.

19. The method of claim 13, further comprising:
generating a first plurality of mappings based at least in part on identifying the plurality of superblocks, wherein accessing the data associated with the first superblock, the second superblock, the third superblock, or any combination thereof is based at least in part on generating the first plurality of mappings.

20. The method of claim 19, wherein:
a first set of the first plurality of mappings correspond to one or more complete superblocks of the plurality of superblocks; and
a second set of the first plurality of mappings correspond to a plurality of incomplete superblocks of the plurality of superblocks.

21. The method of claim 20, wherein generating the first plurality of mappings comprises:
including the first superblock and the third superblock in the first set of the first plurality of mappings based at least in part on the first superblock being a complete superblock prior to dedicating the first physical block to the second superblock and the third superblock being a complete superblock prior to dedicating the second physical block to the second superblock; and
including a fourth superblock of the plurality of superblocks in the second set of the first plurality of mappings based at least in part on the fourth superblock being an incomplete superblock.

22. The method of claim 20, wherein:
a first subset of the first set of the first plurality of mappings correspond to a first subset of superblocks of the plurality of superblocks based at least in part on respective indices associated with the first subset of superblocks of the plurality of superblocks; and
a second subset of the first set of the first plurality of mappings comprise at least the first superblock and the third superblock based at least in part on a first index associated with the first superblock and a second index associated with the third superblock being greater than each of the respective indices associated with the first subset of superblocks of the plurality of superblocks.

23. The method of claim 13, further comprising:
replacing at least one physical block of the first superblock, the third superblock, or both before dedicating the first physical block and the second physical block to the second superblock.

24. The method of claim 23, further comprising:
generating a second plurality of mappings based at least in part on replacing the at least one physical block of the first superblock, the third superblock, or both, wherein the second plurality of mappings comprises associations between logical addresses and physical addresses of respective physical blocks of the first superblock, the second superblock, and the third superblock.

25. A non-transitory computer-readable medium storing code, the code comprising instructions executable by one or more processors to:
dedicate a first physical block of a first superblock of a plurality of superblocks to a second superblock of the plurality of superblocks;
dedicate a second physical block of a third superblock of the plurality of superblocks to the second superblock, wherein each of the first superblock and the third superblock comprise a full complement of good physical blocks prior to dedicating physical blocks to the second superblock; and
access data associated with the first superblock, the second superblock, the third superblock, or any combination thereof based at least in part on dedicating the first physical block and the second physical block to the second superblock.
